(19) United States
(12) Patent Application Publication
(10) Pub. No.: US 2007/0252850 A1
(43) Pub. Date: Nov. 1, 2007

(54) Image processing method and image processing apparatus

(75) Inventors: Michiko Fujiwara, Yamatokoriyama-shi (JP); Tatsuya Tanaka, Yamatokoriyama-shi (JP); Norihide Yasuoka, Nara-shi (JP); Tomoe Matsuoka, Nara-shi (JP); Masahiro Okuyama, Yamatokoriyama-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/790,616

(22) Filed: Apr. 26, 2007

(30) Foreign Application Priority Data
Apr. 26, 2006 (JP) 2006-122717

(51) Int. Cl. G09G 5/02

(52) U.S. Cl. 345/604

(57) ABSTRACT

Image processing method and image processing apparatus capable of reducing data volume further after JPEG compression are provided. RGB data is first converted into YUV data, and then scale conversion of luminance value and color-difference value of the YUV data is performed. Discrete cosine transform of the scale-converted YUV data is performed, and the data after the discrete cosine transform is coded into a Huffman code.

### CROSS-REFERENCE TO RELATED APPLICATION

This application claims priority to Japanese Patent Application No. 2006-122717, which was filed on Apr. 26, 2006, the contents of which, are incorporated herein by reference, in their entirety.

### BACKGROUND OF THE INVENTION

1. Field of the Invention

The present invention relates to an image processing method and apparatus for performing color space conversion.

2. Description of the Related Art

Demand for digital multi-functional machines which realize a plurality of functions relating image formation such as a copying function, a printing function and a facsimile function with a single apparatus is increasing. Since the reductions in the area for installing such an apparatus and in the operating cost are expected, many of such digital multi-functional machines are used particularly in offices, and hence additional functions therefor are increasing.

One of the additional functions is a document filing function. The document filing function is a function to store image data which is processed once, such as image data of copied original documents, input image data from a PC (personal computer) or image data received or sent via the facsimile in a predetermined storage device, and load the stored data when necessary to print or send via facsimile again. In order to realize the function, it is necessary to store the image data in the storage device as many as possible. The amount of image data to be stored in the storage device can be increased not only by simply increasing the capacity of the storage device, but also by reducing the file size of the respective image data.

Reduction in file size of the image data may be achieved by using existing file compression techniques. From the view point of a high compression ratio, JPEG (Joint Photographic Experts Group) compression is often used. As most of the image data handled in the digital multi-functional machines are RGB (R:red, G:green, B:blue) data, when performing the JPEG compression, color space conversion from RGB data to YUV data is performed.

The YUV data is used as moving image data in many cases, and is also used as data to be converted when performing various correcting processes.

A luminance correcting apparatus described in Japanese Unexamined Patent Publication JP-A 2000-125225 corrects the luminance level using YUV data, and then converts the data from the YUV data into RGB data in a downstream process to display on a display device.

An image processing apparatus described in Japanese Unexamined Patent Publication JP-A 2004-112535 converts data into YUV data to perform a spatial filter process.

When converting RGB data into YUV data as in the cases described above, a conversion formula is used. However, because of the characteristics of the conversion formula, the YUV data after the conversion includes values only in specific ranges. For example, when RGB data of 8-bit (256 tones) is converted into YUV data, the values exist where Y falls in a range from 10 to 230, U from 50 to 170, and V from 80 to 190.

In this manner, the values which the YUV data can take are limited, which causes a problem that data volume cannot be reduced sufficiently by the JPEG compression.

### SUMMARY OF THE INVENTION

Hence, it is an object of the invention to provide an image processing method capable of reducing data volume further after JPEG compression.

It is another object of the invention to provide an image processing apparatus capable of reducing data volume further after JPEG compression.

The invention provides an image processing method comprising:

a color space conversion step for converting RGB color space data into YUV color space data;

a scale conversion step for performing scale conversion of luminance value and color-difference value of the YUV color space data;

a discrete cosine transform step for performing discrete cosine transform to the YUV color space data after having been subjected to the scale conversion; and

a coding step for Huffman coding the data after having been subjected to the discrete cosine transform.

According to the invention, in the color space conversion step, RGB color space data is first converted into YUV color space data. Subsequently, in the scale conversion step, the scale conversion of luminance value and color-difference value of the YUV color space data is performed. Then, in the discrete cosine transform step, the discrete cosine transform of the YUV color space data after having been subjected to the scale conversion performed, and in the coding step, the data after having been subjected to the discrete cosine transform is coded into the Huffman code.

With the scale conversion, the color space is utilized maximally, and hence the high-frequency component after the discrete cosine transform may be reduced. Accordingly, data volume after having been subjected to the Huffman coding can be reduced.

In the invention it is preferable that the image processing method further comprises a correcting step for performing a tone correction of the YUV color space data after having been subjected to the scale conversion.

Furthermore, in the invention, it is preferable that γ correction is performed in the correction step.

According to the invention, in the correcting step, a tone correction such as γ correction, for example, is performed for the YUV color space data after having been subjected to the scale conversion.

With the scale conversion, the luminance value and the color-difference value of the YUV color space data are maximally utilized, and hence the correction of higher degree of accuracy is achieved in the tone correction after the conversion. Therefore, the image data with further improved quality can be created.

In the invention, it is preferable that the luminance value and the color-difference value are expanded in the scale conversion step.

In the invention, it is preferable that the luminance value and the color-difference value are level-shifted in the scale conversion step.

According to the invention, the scale conversion is performed by expanding or level-shifting the luminance value and the color-difference value in the scale conversion step.

Accordingly, the luminance value and the color-difference value are easily dispersed so that the tone reproduction property in color expression can be improved.

The invention also provides an image processing apparatus comprising:

a color space conversion section for converting RGB color space data into YUV color space data;

a scale conversion section for performing scale conversion of luminance value and color-difference value of the YUV color space data;

a discrete cosine transform section for performing discrete cosine transform to the YUV color space data after having been subjected to the scale conversion; and

a coding section for Huffman coding the data after having been subjected to the discrete cosine transform.

According to the invention, the color conversion section converts the RGB color space data into the YUV color space data, and the scale conversion section applies the scale conversion to the luminance value and the color-difference value of the YUV color space data. The YUV color space data after having been subjected to the scale conversion is then performed with the discrete cosine transform by the discrete cosine transform section, and the data after having been subjected to the discrete cosine transform is coded into the Huffman code by the coding section.

With the scale conversion, the color space is utilized maximally, and hence the high-frequency component after the discrete cosine transform can be reduced. Accordingly, data volume after the Huffman coding may be reduced.

In the invention, it is preferable that any one of a scanner, a digital still camera and a digital video camera is used as an input section for inputting the RGB color space data.

According to the invention, any one of a scanner, a digital still camera, and a digital video camera is used as an input section for inputting the RGB color space data. Since the RGB color space data input using these input section is limited in range of the concentration value, the tone reproduction property is further improved.

### BRIEF DESCRIPTION OF THE DRAWINGS

Other and further objects, features, and advantages of the invention will be more explicit from the following detailed description taken with reference to the drawings wherein:

FIG. 1 is a block diagram showing a configuration of an image forming apparatus according to an embodiment of the invention;

FIGS. 2A and 2B are flowcharts showing the procedure of JPEG compression/decompression process;

FIG. 3 is a drawing showing an example of γ correction curve;

FIG. 4 is a drawing showing a correction table;

FIGS. 5A and 5B are flowcharts showing the procedure of the JPEG compression/decompression process;

FIG. 6 is a drawing showing an example of a compression curve;

FIG. 7 is a drawing showing a compression table;

FIG. 8 is a drawing showing an example of an expansion curve; and

FIG. 9 is a drawing showing an expansion table.

### DETAILED DESCRIPTION

Now referring to the drawings, preferred embodiments of the invention are described below.

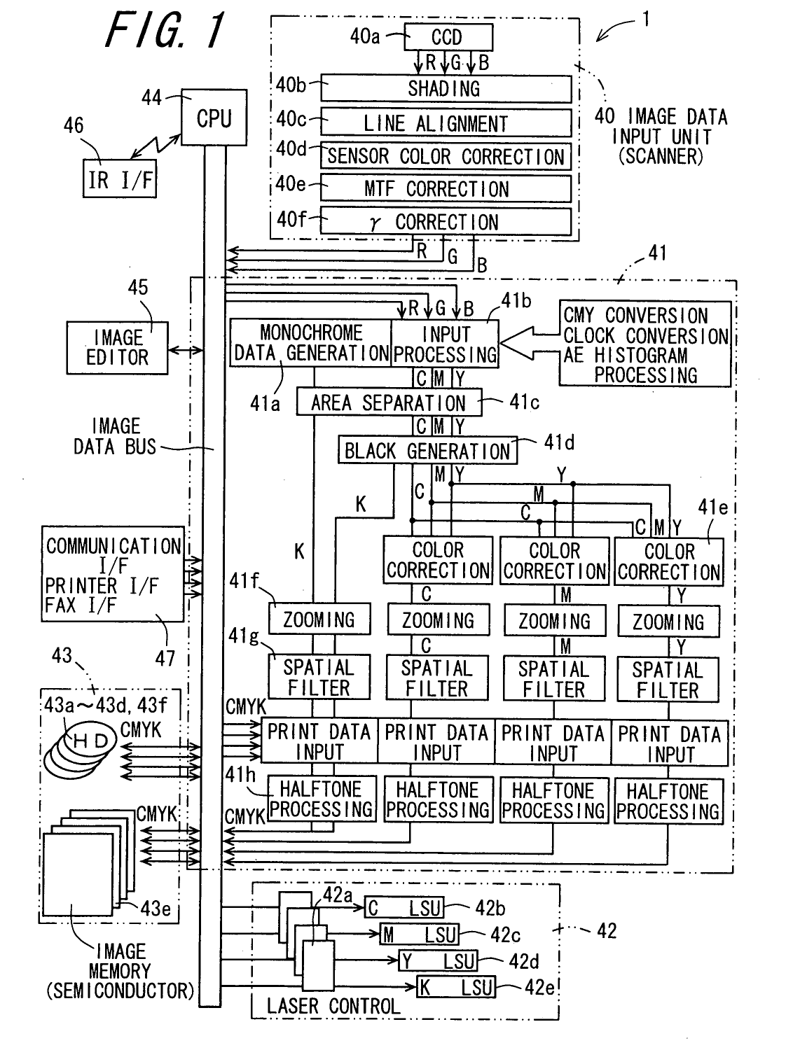

FIG. 1 is a block diagram showing a configuration of an image forming apparatus 1 according to an embodiment of the invention.

The image forming apparatus 1 includes an image data input unit (scanner) 40, an image processor 41, an image data output unit 42, an image memory 43, a CPU (Central Processing Unit) 44, an image editor 45, an IR (infrared ray) interface (I/F) unit 46, and a multi-interface unit 47.

The image data input unit 40 includes a three-line CCD color image sensor 40a which reads a monochrome or color original document, separates the read document into RGB color components by color separation and outputs the same as line data, a shading correction circuit 40b which corrects the line image level of the line data read by the CCD color image sensor 40a, a line alignment unit 40c such as a line buffer for correcting misalignment of the image line data read by the three-line color CCD 40a, a sensor color correction unit 40d for correcting the color data of the respective line data outputted from the three-line CCD color image sensor 40a, and an MTF (Modulation Transfer Function) correction unit 40e for performing correction to give contrast in variations in signals of respective pixels, and an a γ correction unit 40f for correcting the brightness of the image to correct the luminous efficiency.

The image processor 41 includes a monochrome data generating unit 41a for generating monochrome data on the basis of the input RGB color space data (hereinafter, referred to as “RGB data”) from the image data input unit 40, an input processing unit 41b for converting the RGB data into CMY data corresponding to the image data output unit 42, and then performing clock conversion, an area separation unit 41c for separating the input image data into a character area, a half-tone area, and a printing paper photographic area, a black generation unit 41d for performing base color removing process on the basis of the CMY data outputted from the input processing unit 41b to generate black color, a color correction circuit 41e for adjusting the respective colors of the image data on the basis of respective color conversion tables, a zooming circuit 41f for converting the magnification of the input image data on the basis of preset magnification, a spatial filter unit 41g for performing a filtering process, and a halftone processing unit 41h for expressing the tone reproduction property such as a multi-level error diffusing process or a multi-level dither process.

The image data after having been subjected to the halftone process is stored once in the image memory 43. The image memory 43 includes four hard disk drives (HDD) 43a, 43b, 43c and 43d for receiving serial output of 32-bit (8-bit, four colors) image data from the image processor 41 in sequence, storing the same in a buffer temporarily, converting the received and stored image data from the 32-bit data to 8-bit four color image data, and storing the same as the image data for each color for management thereafter. Since the positions of respective laser scanner units are different, the image data of the respective colors are stored once in a delay buffer memory (semiconductor memory) 43e of the image memory 43, and sent to the respective laser scanner units at adequate timing by shifting time to prevent color misalignment.

The image memory 43 includes a filing HDD 43f for storing once processed image data, such as original document image data captured and copied in the image data input unit 40, input image data for printing inputted from the PC, and image data received or sent via facsimile, as JPEG-compressed image data (hereinafter, referred to as JPEG data). The image memory 43 also includes an image combining memory for combining a plurality of images.

The image data output unit 42 includes a laser control unit 42a for modulating the pulse width on the basis of the image data in the respective colors from the halftone processing unit 41h, and laser scanner units 42b, 42c, 42d and 42e for the respective colors for performing laser recording on the basis of the pulse width modulation signals according to the image data of the respective colors outputted from the laser control unit 42a.

The CPU 44 controls the image data input unit 40, the image processor 41, the image memory 43, the image data output unit 42, as well as the image editor 45, described later, the IR interface unit 46 and the multi-interface unit 47 on the basis of a predetermined sequence.

The image editor 45 performs a predetermined image editing on the image data once stored in the image memory 43 via the image data input unit 40, the image processor 41, or an interface, described later. The editing operation of the image data is performed using the image combining memory. The image editor 45 converts the RGB data as the image data into YUV color space data (hereinafter, referred to as “YUV data”) and then performs the JPEG compression to create JPEG data.

The IR interface unit 46 is communication interface section for receiving image data from external image input processing devices (such as communication mobile terminals with a camera, digital still cameras, digital video cameras).

The input image data from the IR interface unit 46 is also input to the image processor 41 once, subjected to the color space correction or the like and converted into a data level which can be handled in the image data output unit 42 of the image forming apparatus 1, to be stored in the HDDs 43a, 43b, 43c and 43d for management thereafter.

The multi-interface unit 47 has a printer interface function for receiving the image data created by the PC, a facsimile (FAX) interface function for converting the image data received via the facsimile into image data which can be outputted by the image data output unit 42 and a communication interface function for receiving the image data from other various types of apparatus. The input image data from the multi-interface unit 47 is already CMYK data, and hence is once subjected to the halftone processing to be stored and managed in the HDDs 43a, 43b, 43c and 43d of the image memory 43.

Here, the JPEG data creating process performed by the image editor 45 will be described in detail.

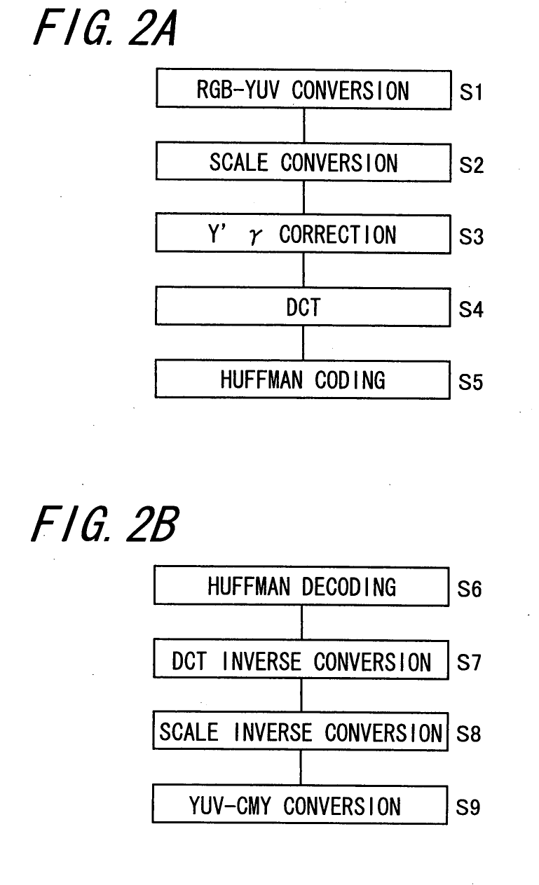

FIGS. 2A and 2B are flowcharts showing the procedure of JPEG compression/decompression process. The image editor 45 performs the JPEG compression process shown in FIG. 2A before storing the RGB data after having been subjected to any of the copying, printing, or facsimile transmission process in the filing HDD 43f.

First, in Step S1, color space conversion from target RGB data to YUV data is performed. Conversion from the RGB data to the YUV data may be performed by calculation on the basis of a conversion formula. However, in this embodiment, the conversion is performed by using LUT (Look Up Table). A table indicating the corresponding relation between the RGB data and the YUV data is prepared in advance on the basis of the conversion formulas below, and hence the conversion process is performed simply by searching the YUV data corresponding to the original RGB data from the table.

When converting the RGB data to the YUV data, the data is optimized according to the characteristics of a reading system, and is converted using conversion formulas shown below.

Y=0.299×R+0.587×G+0.114×B

U=−0.147×R−0.289×G+0.436×B

V=0.615×R−0.515−G−0.100×B

In Step S2, scale conversion of the converted YUV data is performed. The YUV data after having been subjected to the conversion includes Y (luminance value) distributed in the range of 10 to 230, U (color-difference value) in the range of 50 to 170, V (color-difference value) in the range of 80 to 190. Therefore, one of the following two conversions is carried out as the scale conversion.

Conversion 1: Level Shift

U′=U−50

V′=V−80

By the conversion from U to U′ and from V to V′ using the conversion formulas shown above, U′ is shifted to the range of 0 to 120, and V′ is shifted to the range of 0 to 110.

Conversion 2: Expansion

Y′=(Y−10)×(255/220)

U′=(U−50)×(255/120)

V′=(V−80)×(255/110)

By the conversion from Y to Y′, from U to U′ and from V to V′ using the conversion formulas shown above, the Y′, U′ and V′ are expanded respectively to the range of 0 to 255.

Although the scale conversion may be performed by executing calculation on the basis of the conversion formulas shown above, the LUT is employed as in the case of the color space conversion in this embodiment.

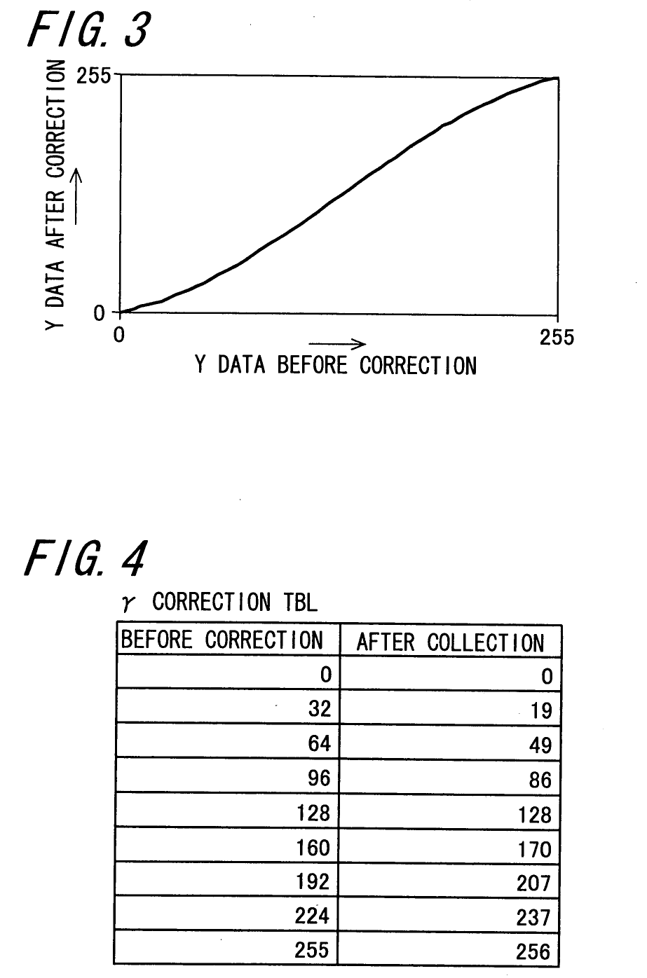

In Step S3, γ correction is performed on the Y data. FIG. 3 is a drawing showing an example of γ correction curve, and FIG. 4 is a drawing showing a correction table. In FIG. 3, the lateral axis represents Y data before the γ correction, and the vertical axis represents Y data after the γ correction.

The target of the correction is Y′ data and, as shown in the drawing, the Y′ data before the correction is expanded to the range of 0 to 255, and a value in the range of 0 to 255 is outputted as data after the correction.

The DCT (discrete cosine transform) is performed in Step S4, and the Huffman coding is performed in Step S5. The DCT and the Huffman coding are the same as the processing performed in the known JPEG compression.

The JPEG data compressed in this manner is stored in the filing HDD 43f. When loading the stored JPEG data for printing, the decompression (decoding) process as shown in FIG. 2B is performed to create the CMY data.

The decompression process is performed by an inversely converting process in the reverse order of the compression process. The JPEG data stored in the filing HDD 43f is read and subjected to Huffman decoding in Step S6. The DCT inverse conversion is performed in Step S7.

In Step S8, the inverse conversion is performed according to the scale conversion executed in Step S2. When the level shift is performed in Step S2, the inverse conversion is performed using the following conversion formulas.

### Inverse Conversion 1

U=U′+50

V=V′+80

When the expansion is performed in Step S2, the inverse conversion is performed using the following conversion formulas.

### Inverse Conversion 2

Y=Y′×(220/255)+10

U=U′×(120/255)+50

V=V′×(110/255)+80

In Step S9, the color space conversion from YUV data to CMY data is performed. Conversion from the YUV data to the CMY data may be performed by executing calculation on the basis of the conversion formula for converting RGB data to the CMY data after having been converted from the YUV data to the RGB data as shown below. However, the LUT is employed in this embodiment.

R=Y+1.14×V

G=Y−0.394×U−0.58×V

B=Y+2.032×U

C=255−R

M=255−G

Y=255−B

or

C=a₁₁×R+a₁₂×G+a₁₃×B+a₁₄

M=a₂₁×R+a₂₂×G+a₂₃×B+a₂₄

Y=a₃₁×R+a₃₂×G+a₃₃×B+a₃₄

The CMY data obtained in this manner is sent to the image processor 41, and is outputted by the image data output unit 42 as printed data.

According to the invention, with the scale conversion, the color space is utilized maximally, and hence the high-frequency component after having been subjected the DCT can be reduced. Accordingly, data volume after the Huffman coding can be reduced. By improving the tone reproduction property in color expression, the quality of the JPEG-compressed image data can be improved.

Next, another embodiment of the invention will be described. The configuration of an image forming apparatus according to this embodiment is the same as that of the image forming apparatus shown in FIG. 1 and hence the description will not be made here again. A different point of this embodiment from the afore-mentioned embodiment is that the compression and expansion are performed on the Y data.

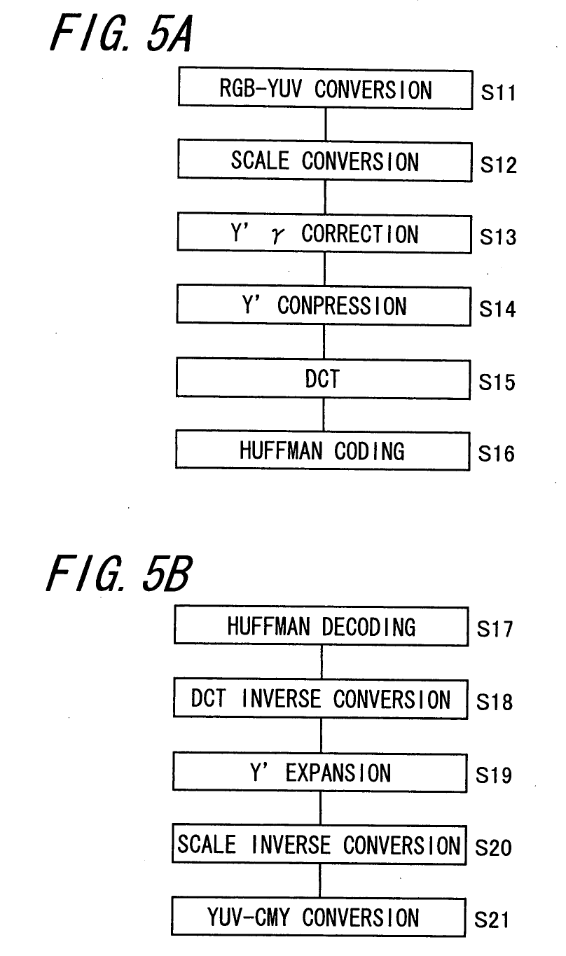

FIGS. 5A and 5B are flowcharts showing the procedure of the JPEG compression/decompression process. The image editor 45 performs the JPEG compression process shown in FIG. 5A before storing the RGB data after having been subjected to any of the copying, printing, or facsimile transmission in the filing HDD 43f.

First, in Step S11, the color space conversion of target RGB data into the YUV data is carried out. Conversion from the RGB data to the YUV data may be performed by calculation on the basis of a conversion formula. However, in this embodiment, the conversion is carried out by LUT. A table indicating the corresponding relation between the RGB data and the YUV data is prepared in advance on the basis of the conversion formulas shown above, and hence the conversion process is performed simply by searching the YUV data corresponding to the original RGB data from the table.

In Step S12, the scale conversion of the converted YUV data is performed. The YUV data after having been subjected to the conversion includes Y distributed in the range of 10 to 230, U in the range of 50 to 170, V in the range of 80 to 190. Therefore, one of the following two conversions is performed as the scale conversion.

Conversion 1: Level Shift

U′=U−50

V′=V−80

By the conversion from U to U′ and from V to V′ using the conversion formulas shown above, U′ is shifted to the range of 0 to 120, and V′ is shifted to the range of 0 to 110.

Conversion 2: Expansion

Y′=(Y−10)×(255/220)

U′=(U−50)×(255/120)

V′=(V−80)×(255/110)

By the conversion from Y to Y′, from U to U′ and from V to V′ using the conversion formulas shown above, the Y′, U′ and V′ are expanded respectively to the range of 0 to 255.

Although the scale conversion may be performed by executing calculation on the basis of the conversion formulas shown above, the LUT is employed as in the case of the color space conversion in this embodiment.

In Step S13, γ correction is performed on the Y′ data. The target of the correction is Y′ data and, as shown in FIG. 3, the Y′ data before the correction is expanded to the range of 0 to 255, and a value in the range of 0 to 255 is outputted as data after the correction.

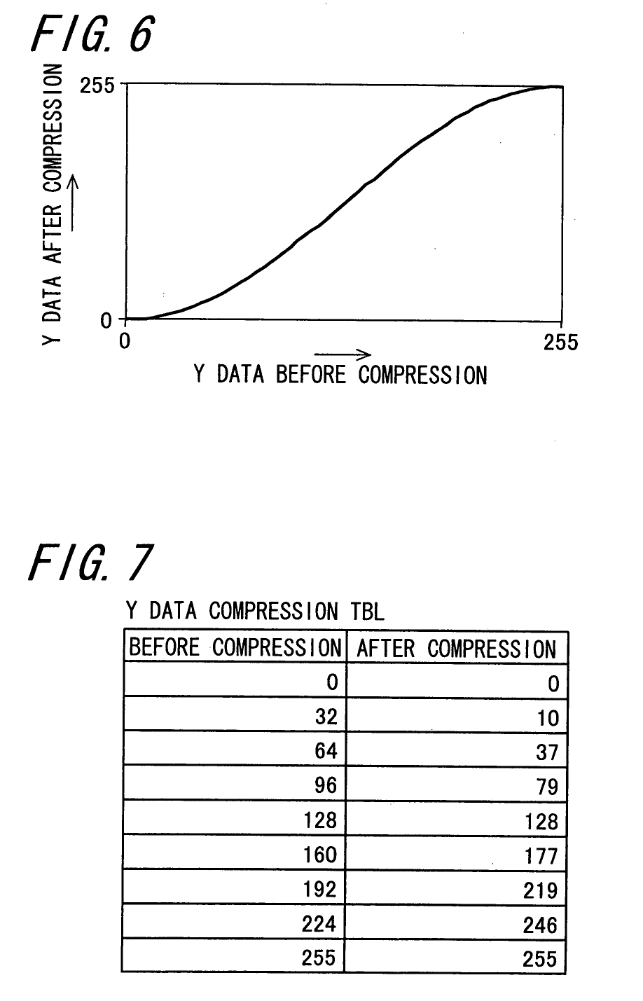

In Step S14, the Y′ data is compressed. FIG. 6 is a drawing showing an example of a compression curve. FIG. 7 is a drawing showing a compression table. The lateral axis represents Y′ data before compression, and the vertical axis represents Y′ data after compression.

The DCT is performed in Step S15, and the Huffman coding is performed in Step S16. The DCT conversion and the Huffman coding are the same as the processing performed in the known JPEG compression.

The JPEG data compressed in this manner is stored in the filing HDD 43f. When loading the stored JPEG data for printing, the decompression (decoding) process as shown in FIG. 5B is performed to create the CMY data.

The decompression process is performed by an inversely converting process in the reverse order of the compression process. The JPEG data stored in the filing HDD 43f is read and subjected to Huffman decoding in Step S17. The DCT inverse conversion is performed in Step S18.

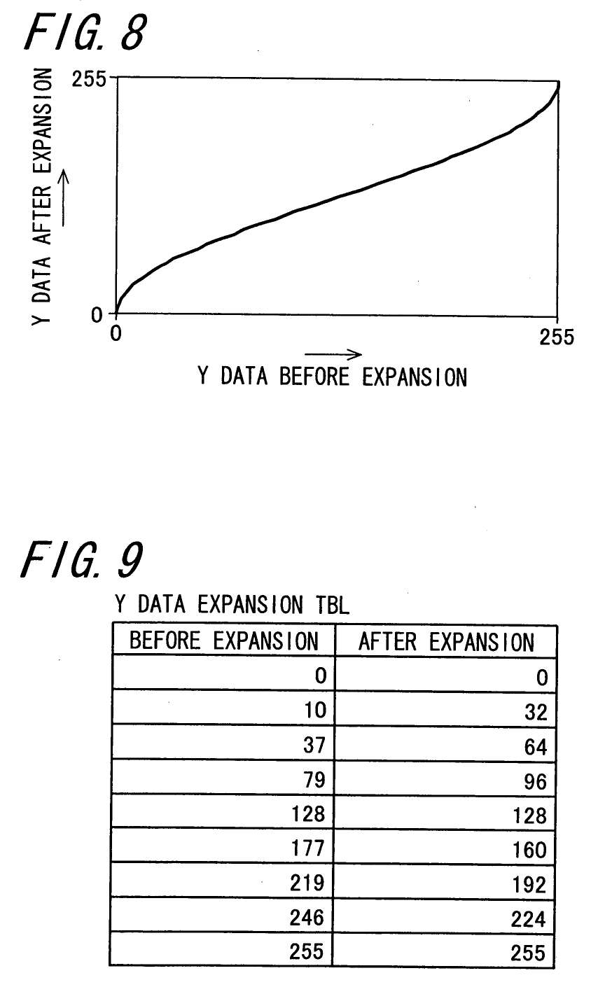

In Step S19, expansion of the Y′ data is performed, The expansion of the Y′ data is an inverse conversion of the compression performed in Step S12. FIG. 8 is a drawing showing an example of an expansion curve, and FIG. 9 is a drawing showing an expansion table. The lateral axis represents the Y′ data before expansion, and the vertical axis represents the Y′ data after expansion.

In Step S20, the inverse conversion is performed according to the scale conversion executed in Step S12. When the level shift is performed in Step S12, the inverse conversion is performed using the following conversion formulas.

### Inverse Conversion 1

U=U′+50

V=V′+80

When the expansion is performed in Step S12, the inverse conversion is performed using the following conversion formulas.

Inverse Conversion 2

Y=Y′×(220/255)+10

U=U′×(120/255)+50

V=V′×(110/255)+80

In Step S21, the color space conversion from YUV data to CMY data is performed. Conversion from the YUV data to the CMY data may be performed by executing calculation on the basis of the conversion formula for converting the RGB data to the CMY data after having been converted from the YUV data to the RGB data as shown below. However, the LUT is employed in this embodiment.

R=Y+1.14×V

G=Y−0.394×U−0.581×V

B=Y+2.032×U

C=255−R

M=255−G

Y=255−B

or

C=a₁₁×R+a₁₂×G+a₁₃×B+a₁₄

M=a₂₁×R+a₂₂×G+a₂₃×B+a₂₄

Y=a₃₁×R+a₃₂×G+a₃₃×B+a₃₄

The CMY data obtained in this manner is sent to the image processor 41, and is outputted by the image data output unit 42 as printed data.

Human luminous efficiency has a logarithm characteristic. Therefore, in the high density area, the influence of quantization errors in association with compression and expansion of the Y data is small. An electronic photography process has a poor reproduction property for highlight (low density area). Therefore, the influence of the quantization errors in association with compression and expansion of the Y′ data is negligible in the low density area.

Therefore, the compression ratio of the JPEG compression is improved and hence deterioration of the image quality is reduced by performing compression and expansion of the Y′ data. The halftone part can hardly be compressed, and hence the compression ratio is low. Therefore, the halftone part is not influenced by the compression and expansion of the Y′ data.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An image processing method comprising:
a color space conversion step for converting RGB color space data into YUV color space data;
a scale conversion step for performing scale conversion of luminance value and color-difference value of the YUV color space data;
a discrete cosine transform step for performing discrete cosine transform to the YUV color space data after having been subjected to the scale conversion; and
a coding step for Huffman coding the data after having been subjected to the discrete cosine transform.

2. The image processing method of claim 1, further comprising a correcting step for performing a tone correction of the YUV color space data after having been subjected to the scale conversion.

3. The image processing method of claim 2, wherein y correction is performed in the correction step.

4. The image processing method of claim 1, wherein the luminance value and the color-difference value are expanded in the scale conversion step.

5. The image processing method of claim 1, wherein the luminance value and the color-difference value are level-shifted in the scale conversion step.

6. An image processing apparatus comprising:
a color space conversion section for converting RGB color space data into YUV color space data;
a scale conversion section for performing scale conversion of luminance value and color-difference value of the YUV color space data;
a discrete cosine transform section for performing discrete cosine transform to the YUV color space data after having been subjected to the scale conversion; and
a coding section for Huffman coding the data after having been subjected to the discrete cosine transform.

7. The image processing apparatus of claim 6, wherein any one of a scanner, a digital still camera and a digital video camera is used as an input section for inputting the RGB color space data.
